(19) United States
(12) Patent Application Publication
(10) Pub. No.: US 2013/0214741 A1
(43) Pub. Date: Aug. 22, 2013

(54) DISCHARGE TYPE BATTERY MANAGEMENT SYSTEM AND METHOD THEREOF

(71) Applicants: JIA-YUAN LEE, Taipei (TW); PIERRE-JEAN BENEY, Henderson, NV (US)

(72) Inventors: JIA-YUAN LEE, Taipei (TW); PIERRE-JEAN BENEY, Henderson, NV (US)

(21) Appl. No.: 13/400,128

(22) Filed: Feb. 20, 2012

(51) Int. Cl. H02J 7/00

(52) U.S. Cl. 320/134

(57) ABSTRACT

In a discharge type battery management system and a method thereof, a monitoring unit is used to monitor a plurality of battery units, and if there is a change of electric potential, current and temperature of the battery units, a control unit controls a plurality of separate energy storage units, so that when the battery pack is charged, at least one of the battery units with a relatively high potential is discharged to equalize the overall electric potential of the battery pack, so as to enhance the energy conversion efficiency.

### BACKGROUND OF THE INVENTION

1. Field of the Invention

The present invention relates to the technical field of electric energy conversion adjustment circuits, in particular to a discharge type battery management system and a method thereof having a control unit to control a discharge switch, and an independent energy storage unit to discharge at least one high-potential battery unit, so as to achieve the effect of equalizing the electric potential of each battery unit.

2. Description of the Related Art

At present, most green transportation means such as electric cars or hybrid cars adopt lithium-iron battery as a repeated discharge battery pack for the supply of kinetic energy. Since a single lithium-iron battery generally has a voltage of approximately 3˜4 volts which much lower than the required driving voltage (100 volts) of the electric or hybrid cars, therefore the battery pack for supplying kinetic power is compulsorily formed by connecting a plurality of lithium-iron battery units in series. However, there generally exists a slight difference of the properties among the battery units, such as a different internal resistance allows accommodating and outputting different electric power during the discharge. After the discharge is repeated for several times, a voltage difference exists between the battery units to cause an unbalanced electric potential between the battery units and lower the performance and efficiency of the battery pack. If the electric potential of the battery unit is too high, the battery will be aged sooner or even burned. On the other hand, if the electric potential is too low, the battery will be aged or damaged easily.

To overcome the aforementioned problem, the conventional methods adopt a bypass resistor connected in parallel with a battery unit with higher electric energy to consume extra electric energy in order to balance the electric potential of each battery unit. However, this passive method of equalizing the electric potential of the battery produces heat by the energy consumption of the resistors and results in an increased temperature that will shorten the service life of the battery pack, lower the energy conversion efficiency, and have difficulty of expansion.

### SUMMARY OF THE INVENTION

In view of the problems of the prior art, it is a primary objective of the present invention to provide a discharge type battery management system and a method thereof, wherein a monitoring unit is used to monitor the electric potential, current and temperature of the plurality of battery units of a battery pack that is charged by a power supply, and the monitoring unit compares an electric potential equilibrium state of the battery units, so that if at least one of the battery units has a relatively higher potential, the monitoring unit will output a discharge signal to a control unit. The control unit receives the discharge signal to electrically conduct a corresponding first switch, so that when the corresponding battery unit is charged, electric energy is discharged to a second coil of a corresponding energy storage unit at the same time With the mutual inductance effect of the second coil and the corresponding first coil, the discharged electric energy is transmitted to the corresponding first coil, and then stored into the corresponding energy storage unit, and fed back to the system. Therefore, the separated energy storage units can drive the battery units to discharge electric energy simultaneously or separately to equalize the electric potential of each of the battery units, so as to achieve the effects of enhancing the conversion efficiency of the battery pack and delaying the aging of the battery.

To prevent the battery pack from being damaged by an overcharge, the discharge type battery management system and method of the present invention further turns off the power supply coupled to the power supply by the control unit and a second switch installed between the control unit and the energy storage units to stop the power supply to supply electric power if the monitoring unit detects that the charge current of the battery pack is too large, and a power disconnection signal is outputted to the control unit if the electric potential is saturated or the temperature is too high.

On the other hand, to prevent the battery units from discharging excessively to expedite the aging of the battery, the discharge type battery management system and method thereof of the present invention further drives the control unit to stop the battery pack to discharge through a discharge protection unit, if the monitoring unit detects that the electric potential of the battery units is too low and an abnormal signal is outputted to the control unit.

To improve the electricity storage efficiency of the battery pack, each of the first coils is coupled to a synchronous rectifier element through a third switch, so that the energy storage unit synchronously rectifies the voltage of the power supply to charge the battery units.

### BRIEF DESCRIPTION OF THE DRAWINGS

FIG. 1 is a schematic circuit diagram of a first preferred embodiment of the present invention;

FIG. 2 is a schematic circuit diagram of a second preferred embodiment of the present invention; and

FIG. 3 is a flow chart of the present invention.

### DETAILED DESCRIPTION OF THE PREFERRED EMBODIMENTS

The technical content of the present invention will become apparent with the detailed description of preferred embodiments and the illustration of related drawings as follows.

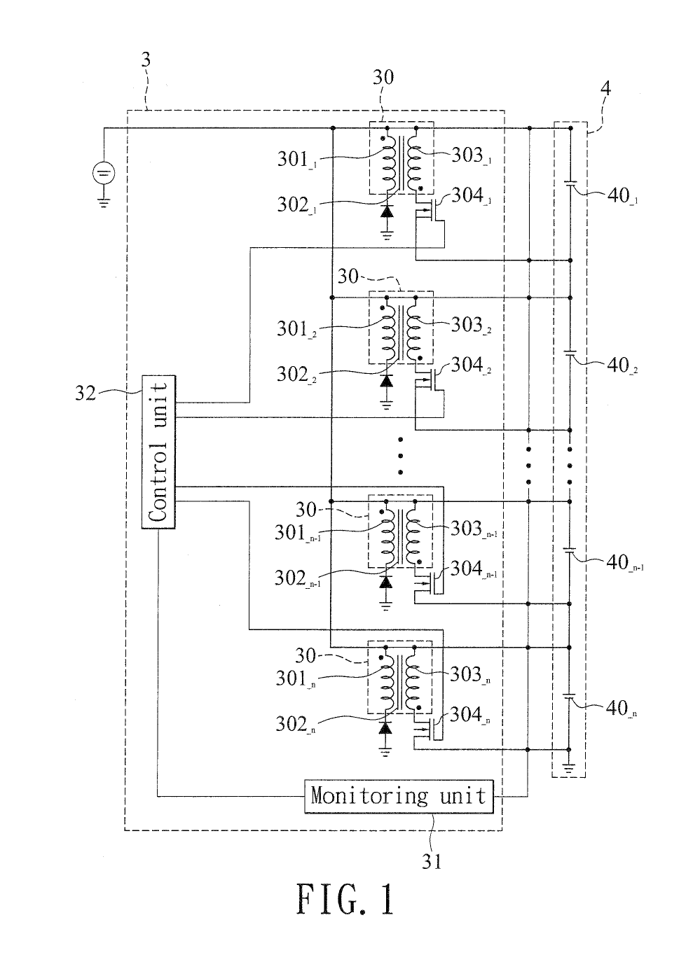

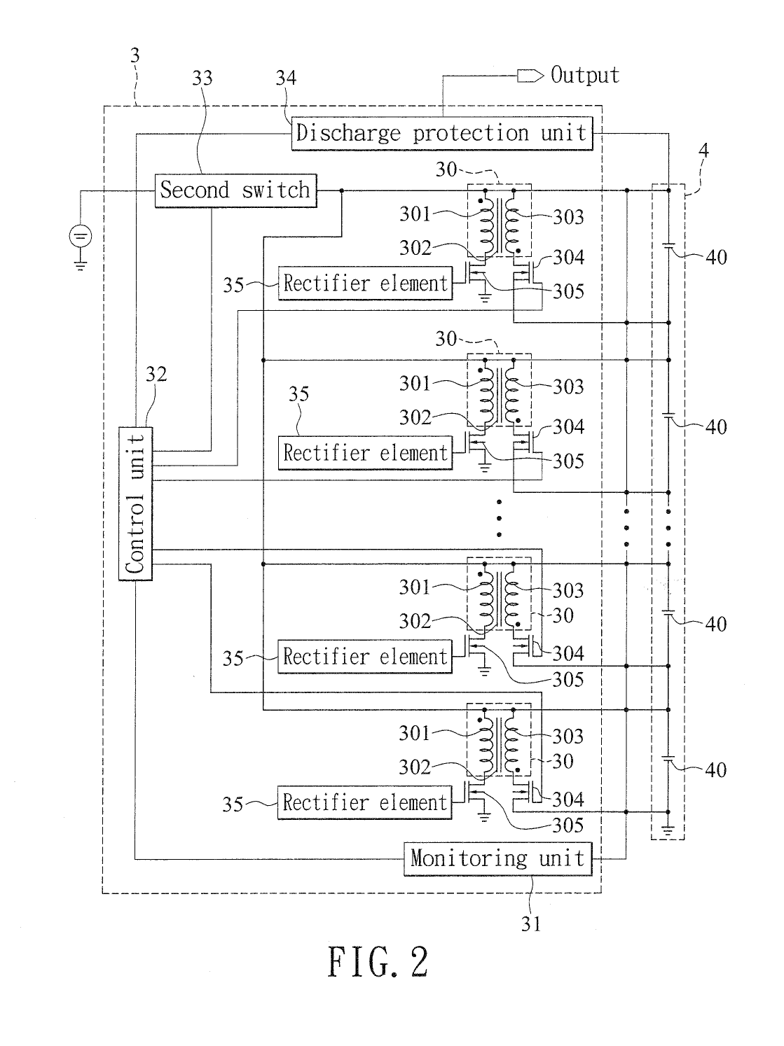

With reference to FIGS. 1 and 2 for schematic circuit diagrams of the first and second preferred embodiments of the present invention respectively, the discharge type battery management system 3 is used for charging and monitoring a plurality of battery units 40 of a battery pack 4. The discharge type battery management system 3 comprises a plurality of energy storage units 30, a monitoring unit 31, a control unit 32, a second switch 33 and a discharge protection unit 34. Each energy storage unit 30 comprises a first coil 301, a magnetic core 302 and a second coil 303, wherein each first coil 301 is coupled to the second coil 303 through the magnetic core 302, and each second coil 303 is coupled to the battery unit 40 through a first switch 304. The monitoring unit 31 is electrically coupled to the battery units 40 and the control unit 32. The control unit 32 is coupled to the first switch 304 and generally situated at an idle state, and the control unit 32 is turned on only if the monitoring unit 31 detects an abnormal condition and issue a signal in order to save the power consumption for the idling. The second switch 33 is coupled between the power supply, and the energy storage units 30 and the control unit 32, and the discharge protection unit 34 is coupled to the control unit 32 and the battery pack 4.

The monitoring unit 31 monitors the electric potential, current and temperature of the battery units 40 to examine whether the battery units 40 has no over-heat, over-current, or too-low potential and outputs a discharge current. If there is an over-heat, over-current, and too-low potential, then the control unit 32 will enable the discharge function of the battery unit 40, or else the control unit 32 will disable the discharge function. If the charge current of the battery pack 4 is too large or the temperature is too high, the monitoring unit 31 compares and determines whether the state of the electric potential of the battery units 40 reaches a saturated state. If the electric energy of a certain battery unit 40₋₁ is greater than a maximum electric power value such as 3.65 volts, a power disconnection signal and a discharge signal will be outputted to the control unit 32, so that the control unit 32 turns off the second switch 33 to stop the input of power supply in order to avoid abnormal errors at the input terminal and prevent the battery pack 4 from being overcharged or burned. In the meantime, the control unit 32 electrically conduct the corresponding first switch 304₋₁ to discharge extra electric energy to the corresponding second coil 303₋₁ when the corresponding battery unit 40-1 is charged, and the mutual inductance effect of the second coil 303 and the first coil 301 transmits the electric energy to the corresponding first coil 301₋₁ and temporarily stores the electric energy into the energy storage units 30₋₁, and feeds the electric energy back to the system. It is noteworthy to point out that the second switch 33 is an electronic switch that has a low power consumption and can bear a working current over 200 amperes to avoid damages to the circuit caused by sparks produced at the moment of shutting down the system, wherein the total power consumption at a full load is less than 50 watts, so that the invention can save electric power and comply with the environmental protection requirements.

On the other hand, if voltage of the battery unit 40 is not greater than 3.65 volts, the monitoring unit 31 will further determine whether the error of electric potential of each of the battery units 40 is smaller than a predetermined error value such as ±0.05 volts. If yes, then the battery unit 40 is detected again to determine whether it is charged or discharged, and the battery units 40 are monitored continuously or the monitoring operation is ended and the system is idled. If the error of the electric potential of each of the battery units 40 is greater than ±0.05 volts, then the discharge signal will be issued to the control unit 32 to turn on the corresponding two first switches 304₋₂, 304₋ₙ, so that the two battery units 40₋₂, 40₋ₙ having an electric potential greater than the average electric potential of the battery pack 4 discharge the electric energy to the corresponding two second coils 303₋₂, 303₋ₙ, and then the corresponding two first coils 301₋₂, 301₋ₙ will temporarily store the discharged electric energy into the corresponding two energy storage units 30₋₂, 30₋ₙ and the discharged electric energy is fed back to the system. Therefore, the electric energy will not be wasted, and the electric potential between the battery units 40 can be equalized to enhance the efficiency of charging the battery pack 4. The invention can be applied to a large current, such as an application on the battery units 40 connected in series to increase the voltage up to 384 volts in order to provide an active electric potential balancing system in charge equipments for the high-voltage battery pack 4.

In addition, if the monitoring unit 31 detects that the electric potential of the battery units 40 is too low, an abnormal signal will be outputted to the control unit 32, so that the control unit 32 will stop the battery pack 4 to discharge through the discharge protection unit 34 and avoid the battery units 40 from being discharged excessively to cause damages and aging of the battery. Therefore, the discharge type battery management system 3 can protect the battery pack 4 through the monitoring unit 31, the second switch 33 and the discharge protection unit 34.

In addition, each of the first coils 301 is an asynchronous rectifier element of a diode which can be connected in series with one another and provided for filtering and rectifying the charge current while adjusting the charge cycle. Further, each of the first coils 301 is a third switch 305 of MOSFET coupled to a synchronous rectifier element 35. If the third switch 305 is electrically conducted, the energy storage unit 30 will synchronously rectify the voltage of the power supply to charge the battery units 40 to improve the conversion efficiency of the electric energy up to a level more than 70%.

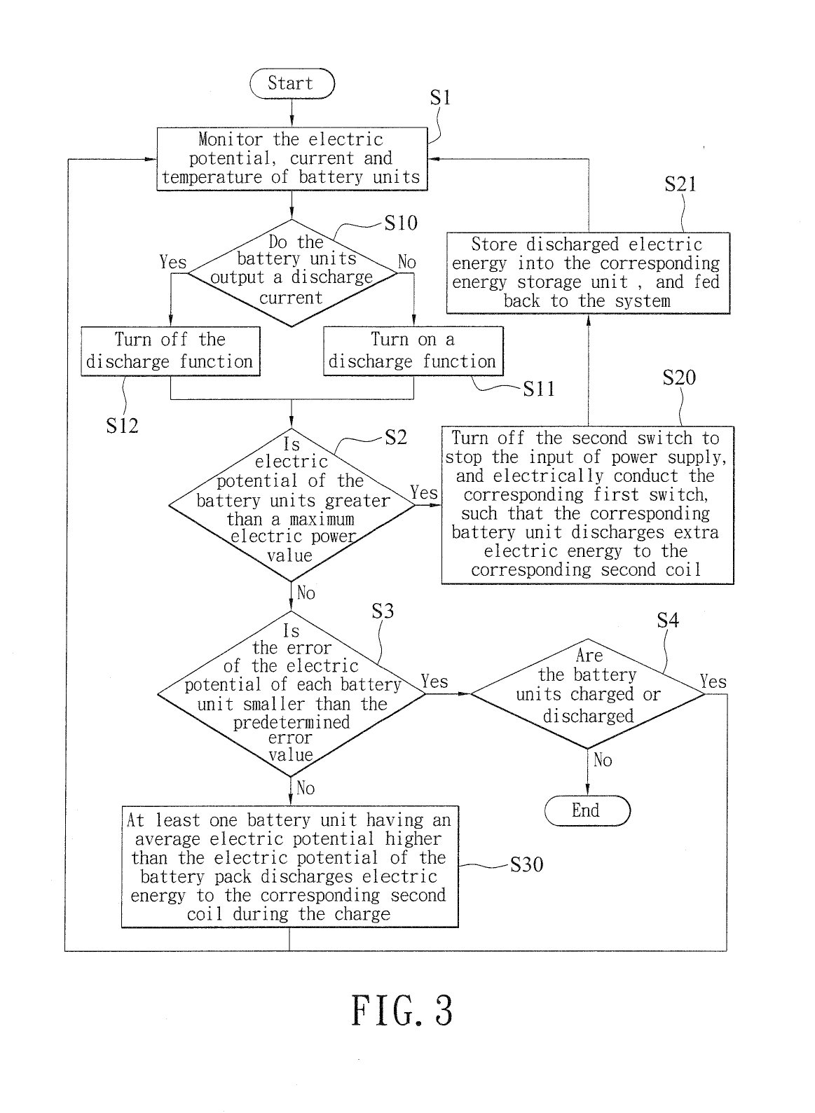

With reference to FIG. 3 for a flow chart of a preferred embodiment of the present invention, the discharge type battery management method is an operation method applied to manage the aforementioned discharge type battery management system 3 and equalize the electric potential of the battery units 40, and the method of the invention comprises the following steps:

S1: Start a charging operation of the battery pack 4, and use the monitoring unit 31 to monitor the electric potential, current and temperature of the battery units 40.

S10: Detect whether the battery units 40 output a discharge current.

S11: Turn on a discharge function by the control unit 32, if the battery units 40 output a discharge current, or else go to step S12 to turn off the discharge function.

S2: The monitoring unit 31 compares the state of electric potential of the battery units 40 to confirm whether the electric energy stored in the battery units 40 is greater than the maximum electric power value. If yes, then go to S20, or else go to S3.

S20: Output the power disconnection signal to the control unit 32 to turn off the second switch 33 to stop the input of power supply, and output the discharge signal to the control unit 32 at the same time to electrically conduct the corresponding first switch 304, such that the corresponding battery unit 40 discharges extra electric energy to the corresponding second coil 303.

S21: Transmit the discharged electric energy to the corresponding first coil 301 through a mutual inductance effect of the second coil 303 and the first coil 301, and temporarily store the discharged electric energy into the corresponding energy storage unit 30, and fed back to the system.

S3: The monitoring unit 31 further determines whether the error of the electric potential of each battery unit 40 is smaller than the predetermined error value. If yes, then execute S4, or else enter into S30 to issue the discharge signal to the control unit 32 in order to electrically conduct the corresponding first switch 304, such that the at least one battery unit 40 having an average electric potential higher than the electric potential of the battery pack 4 discharges electric energy to the corresponding second coil 303 during the charge, and the discharged electric energy is stored into the energy storage unit 30 through the corresponding first coil 301 and fed back to the system.

S4: Detect whether the battery unit 40 is charged or discharged, and continue monitoring the battery units 40 if the battery unit 40 is charged or discharged, or else end the monitoring operation and idle the system.

What is claimed is:

1. A discharge type battery management system, applicable for monitoring and using a power supply to charge a plurality of battery units of a battery pack, and equalizing the quantity of electric power of each of the battery units through an independent discharge method, comprising:
a plurality of energy storage units, coupled to the power supply and the battery pack, and each energy storage unit comprising a first coil, a magnetic core and a second coil, and each first coil being coupled to the second coil through the magnetic core, and each second coil being coupled to the battery unit through a first switch;
a monitoring unit, electrically coupled to the battery units, and used to monitor the electric potential, current and temperature of the battery units, and compare a potential equilibrium state of the battery units, such that when at least one of the battery units has a relatively higher potential, the monitoring unit outputs a discharge signal; and
a control unit, coupled to the energy storage units and the monitoring unit, and used to receive the discharge signal to electrically conduct the corresponding first switch, so as to discharge electric energy to the corresponding second coil while the corresponding battery unit is charged, and after the discharged electric energy is transmitted to the corresponding first coil through a mutual inductance effect of the second coil and the first coil, the electric energy stored in the energy storage unit is fed back to the system.

2. The discharge type battery management system of claim 1, further comprising a second switch coupled to the power supply, the energy storage units and the control unit, and when the monitoring unit detects a too-large charge current of the battery pack, a saturation electric potential or a too-high temperature, the monitoring unit is capable of outputting a power disconnection signal to the control unit so that the control unit turns off the second switch to stop the power supply to supply electric power.

3. The discharge type battery management system of claim 1, further comprising a discharge protection unit coupled to the control unit and the battery pack, and when the monitoring unit detects a too-low electric potential of the battery units, an abnormal signal is outputted to the control unit, so that the control unit stops the battery pack to discharge electric power through the discharge protection unit.

4. The discharge type battery management system of claim 1, wherein each first coil is coupled to a synchronous rectifier element through a third switch, so that the energy storage unit synchronously rectifies the voltage of the power supply to charge the battery unit.

5. A discharge type battery management method, applied to a discharge type battery management system for monitoring and using a power supply to charge a plurality of battery units of a battery pack through an independent discharge method and equalizing electric power of each of the battery units as recited in claim 1, comprising the steps of:
using the monitoring unit to monitor electric potential, current and temperature of the battery units;
comparing an electric potential equilibrium state of the battery units;
outputting a discharge signal to the control unit by the monitoring unit when at least one of the battery units has a relatively higher potential;
receiving the discharge signal, such that the control unit electrically conducts the first switch; and
discharging electric energy to the corresponding second coil while the corresponding battery unit is charged, and feeding the corresponding electric energy stored in the corresponding energy storage unit back to the system, after the discharged electric energy is transmitted through a mutual inductance effect of the second coil and the first coil.
